(19) United States
(12) Patent Application Publication
(10) Pub. No.: US 2015/0318117 A1
(43) Pub. Date: Nov. 5, 2015

(54) CAPACITOR AND MANUFACTURING METHOD THEREFOR

(71) Applicant: NIPPON CHEMI-CON CORPORATION, Tokyo (JP)

(72) Inventors: Yutaka Harashima, Tokyo (JP); Hiroshi Nekozuka, Tokyo (JP)

(73) Assignee: NIPPON CHEMI-CON CORPORATION, Tokyo (JP)

(21) Appl. No.: 14/799,923

(22) Filed: Jul. 15, 2015

Related U.S. Application Data
(63) Continuation of application No. PCT/JP2014/000214, filed on Jan. 17, 2014.

(30) Foreign Application Priority Data
Jan. 18, 2013 (JP) 2013-007093
Apr. 1, 2013 (JP) 2013-075751

(51) Int. Cl. H01G 9/012; H01G 9/08; H01G 9/15; H01G 9/00

(52) U.S. Cl. CPC H01G 9/012; H01G 9/0029; H01G 9/08; H01G 9/15

(57) ABSTRACT

A capacitor element of a capacitor is connected to a lead terminal and is covered with a resin. The lead terminal is derived from a resin layer covering the capacitor element and includes an interval portion exposed from an outer face of the resin layer, a small-thickness portion, and a step portion that is a border portion between the interval portion and the small-thickness portion. The small-thickness portion is bent toward the step portion, is disposed on a side of the resin layer and is disposed to superpose the small-thickness portion on the step portion and to surround the interval portion.

### CROSS REFERENCE TO RELATED APPLICATIONS

This application is a continuation of International Application No. PCT/JP2014/000214, filed on Jan. 17, 2014, which is entitled to the benefit of priority of Japanese Patent Application No. 2013-007093, filed on Jan. 18, 2013 and Japanese Patent Application No. 2013-075751, filed on Apr. 1, 2013, the contents of which are hereby incorporated by reference.

### BACKGROUND OF THE INVENTION

i) Field of the Invention

The present invention relates to a capacitor such as a solid electrolytic capacitor whose outer packaging member is formed using a resin mold, and a manufacturing method therefor.

ii) Description of the Related Art

As to a capacitor whose outer packaging is applied thereto using a resin mold, lead terminals of a capacitor element thereof are drawn from a resin layer. The lead terminals are bent along the face of the resin layer to be processed into face bonding terminals. To this type of capacitor, height reduction to suppress the height thereof is demanded. With a capacitor having a reduced height, the height thereof can be reduced on a mounting substrate and this contributes to downsizing and weight reduction of a device on which the capacitor is mounted.

It is known about this type of capacitor that a seat plate is attached to the capacitor on the side of a lead terminal drawing portion thereof and lead terminals are bent on this seat plate (for example, Japanese Patent Application Laid-Open Publication No. 2000-021683). It is also known that a capacitor element is molded using an insulating resin and lead terminals drawn from a resin layer are connected to a terminal board (for example, Japanese Patent Application Laid-Open Publication No. 2003-272962). As above, the height reduction of the capacitor is degraded with a configuration including the seat plate or the terminal board.

### BRIEF SUMMARY OF THE INVENTION

As to the capacitor whose lead terminals are drawn from the resin layer, lead terminals used to connect the capacitor to a substrate by face bonding are processed to be bent along the resin layer. The lead terminals however have elasticity attributed to the material thereof and, even when the lead terminals are bent along the resin layer, the lead terminals recover from their bent figures (springing back) due to the elasticity. With the lead terminals recovering from their bent figures, the mounting face of the capacitor is not in parallel to the mounting substrate and the mounting stability of the capacitor is poor. A notch is formed in each of the lead terminals to determine the bending position of the lead terminal using the notch, and the recovery from the bent figure is prevented by reducing the elasticity. For lead terminals each having a column-like shape, the placement stability of the capacitor for the mounting substrate is improved by flattening the substrate mounting face of each of the lead terminals.

Based on such demands, the lead terminals derived from the resin layer are traditionally applied with the bending process after the flattening process or the formation of the notch.

FIG. 6 depicts an example of processing steps for a lead terminal. These processing steps include, for example, the flattening process step, the notch formation step, and the bending step for the lead terminal.

In the flattening process and the notch formation, for example, as depicted in “A” of FIG. 6, the lead terminal 104 drawn from a resin layer 102 covering a capacitor element 100 is sandwiched between metal molds 106-1 and 106-2 and the metal molds 106-1 and 106-2 are directed and pressurized in directions indicated by arrows to shape the lead terminal 104. The pressing face of the metal mold 106-1 is a flat face while the metal mold 106-2 has a convex portion 108 and a flat face 110 formed thereon. As depicted in B of FIG. 6, a notch 112 and a flat face 114 are thereby formed on the lead terminal 104 from the side of the resin layer 102. When the notch 112 and the flat face 114 are formed, a stretched portion 116 is generated in the lead terminal 104 in the vicinity of the resin layer 102.

As depicted in C of FIG. 6, the lead terminal 104 is bent in the portion of the notch 112 and the notch 112 is inwardly bent. For example, as depicted in D of FIG. 6, in this bending, a corner portion 120 facing the notch 112 abuts on a step portion 118 generated in the formation of the notch 112 and the bending of the lead terminal 104 is obstructed. The lead terminal 104 therefore cannot be flatly bent even with the notch 112 formed thereon.

Taking into consideration the above problem, an object of the present invention is to provide a capacitor including lead terminals whose recovery from their bent figures is prevented and whose flattening process is realized, and a manufacturing method therefor.

According to an aspect of a capacitor of the present invention, the capacitor is a capacitor including a capacitor element to which a lead terminal is connected and that is covered with a resin. The lead terminals may be derived from a resin layer covering the capacitor element, and may include an interval portion exposed from an outer surface of the resin layer, a small-thickness portion, and a step portion that is a border portion between the interval portion and the small-thickness portion. The small-thickness portion may be bent toward the step portion, is disposed on a side of the resin layer and is disposed to superpose the small-thickness portion on the step portion and to surround the interval portion.

According to an aspect of a manufacturing method for a capacitor of the present invention, the manufacturing method is a manufacturing method for a capacitor including a capacitor element to which a lead terminal is connected and that is covered with a resin. The manufacturing method may include deriving the lead terminal from a resin layer covering the capacitor element, and exposing an interval portion from an outer face of the resin layer, forming a small-thickness portion in the lead terminal to dispose a step portion between the interval portion and the small-thickness portion, and bending the lead terminal in the small-thickness portion toward the step portion and disposing the small-thickness portion to superpose the small-thickness portion on the step portion and to surround the interval portion.

Other objects, features, and advantages of the present invention will become more apparent when reading the embodiments herein with reference to the accompanying drawings.

### BRIEF DESCRIPTION OF THE SEVERAL VIEWS OF THE DRAWING

FIG. 1 is a partially cutout diagram of an example of a capacitor and a lead terminal thereof according to a first embodiment.

FIG. 2 is a partially cutout diagram of an example of a capacitor and a lead terminal thereof according to a second embodiment.

FIG. 3 is a cross-sectional diagram of an example of a capacitor and lead terminals thereof according to a third embodiment.

FIG. 4 is a diagram of a capacitor whose lead terminals are applied with a bending process, and the lead terminal.

FIG. 5 is a diagram of a capacitor and lead terminals thereof according to a fourth embodiment, and the state of the lead terminal applied with a bending process.

FIG. 6 is a diagram of a lead terminal of a capacitor of related art and a bending process applied thereto.

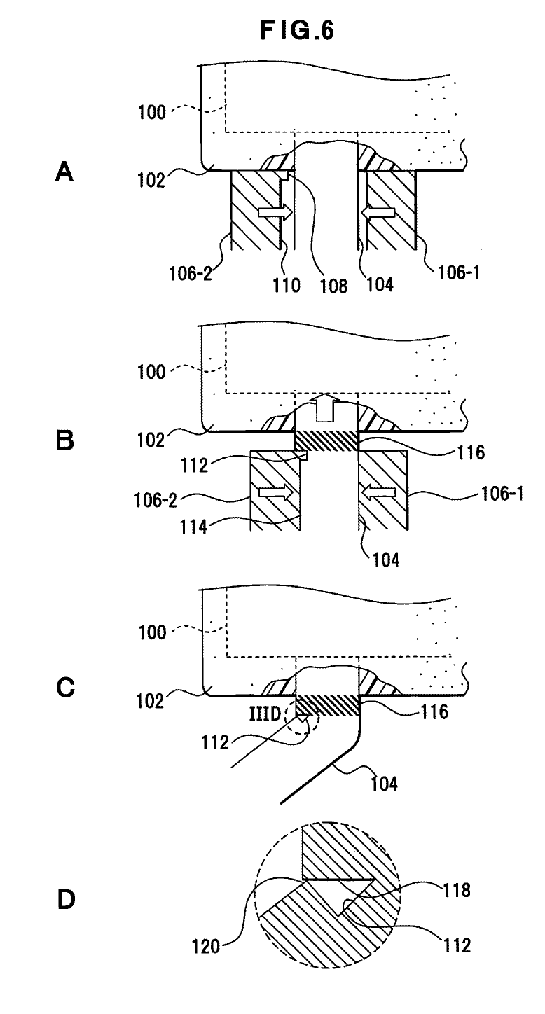

### DETAILED DESCRIPTION OF THE INVENTION

### First Embodiment

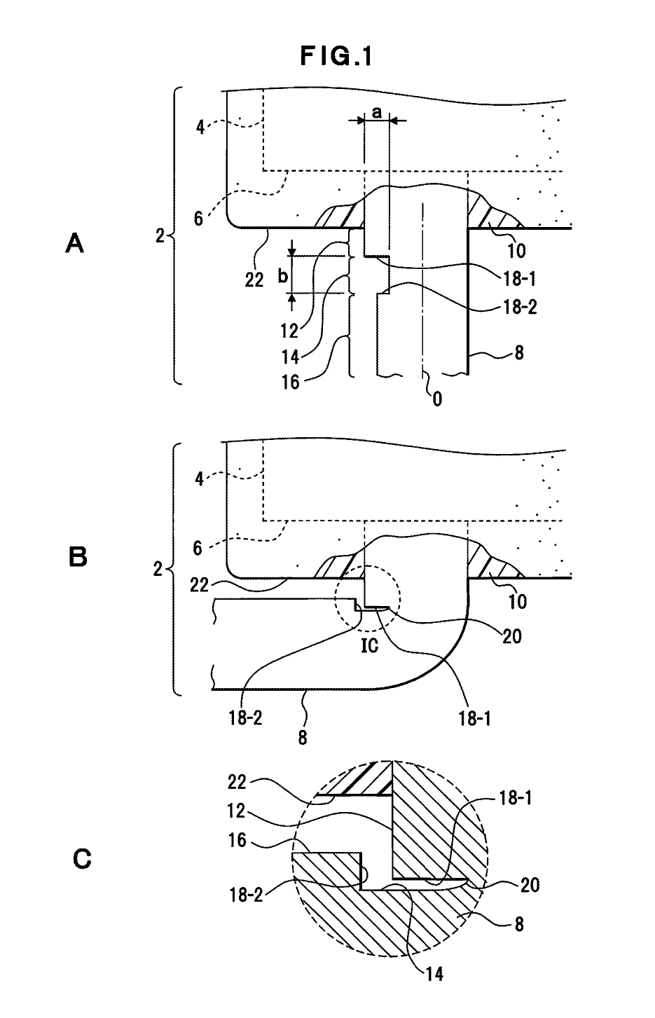

“A” of FIG. 1 depicts a portion of a capacitor according to a first embodiment. The configuration depicted in “A” of FIG. 1 is an example and the present invention is not limited to this configuration.

The capacitor 2 is, for example, a solid electrolytic capacitor and is an example of the capacitor of the present invention.

For example, a capacitor element 4 wound in a cylinder-like shape is used in the capacitor 2. As an example, in the capacitor element 4, an anode electrode foil, a first separator, a cathode electrode foil, and a second separator are stacked on each other, are wound in a cylinder-like shape, and are thereafter impregnated with an electrolyte. An anode lead terminal is connected to the anode electrode foil of the capacitor element 4, and a cathode lead terminal is connected to the cathode electrode foil thereof. These lead terminals are drawn from an element end face 6 of the capacitor element 4. A depicted lead terminal 8 may be either the anode or the cathode lead terminal.

The capacitor element 4 has a resin mold applied thereto using an insulating resin, and is covered with a resin layer 10. The lead terminal 8 drawn from the capacitor element 4 penetrates the resin layer 10 and is drawn from the resin layer 10.

A stretched portion 12, a notch 14, and a flat portion 16 are formed in the lead terminal 8 by shaping processing using a mold. The stretched portion 12 is a stretched region generated in the lead terminal 8 by the shaping processing, and is produced in the border portion with the resin layer 10. The stretched portion 12 is an example of an interval portion between the resin layer 10 and the notch 14, and is a bar-like portion having the same diameter. The notch 14 is an example of a small-thickness portion.

The notch 14 is an example of the small-thickness portion formed in the lead terminal 8. The notch 14 includes a first step portion 18-1 between the notch 14 and the stretched portion 12, and a second step portion 18-2 between the notch 14 and the flat portion 16. The step portions 18-1 and 18-2 each include, for example, a standing wall face formed in a direction perpendicular to or intersecting with the central axis “0” of the lead terminal 8.

Denoting the height of the step portion 18-1 as “a” and the width of the notch 14 as “b”, the width b is set to have a relation of a<b for the height “a”. The width b is set to be larger than the height “a”.

The lead terminal 8 in which the notch 14 is formed is bent in the direction toward the notch on the side of the step portion 18-1 of the notch 14. B of FIG. 1 depicts the lead terminal 8 bent in the corner portion between the step portion 18-1 and the notch 14.

When the lead terminal 8 is bent in the above position, as depicted in C of FIG. 1, a bent portion 20 is formed and the notch 14 is thereby superposed on the step portion 18-1. The lead terminal 8 can be disposed in parallel to a lead terminal drawing face 22 of the resin layer 10. The bent portion 20 is set to be, for example, in a portion of the notch 14 or in the border portion between the notch 14 and the step portion 18-1, and is formed in a “V”-shape having the notch 14 and the step portion 18-1 as its sides. In this case, because the width b of the notch 14 is larger than the height “a” of the step portion 18-1, the step portion 18-2 of the notch 14 outreaches the wall face of the lead terminal 8 and is disposed, and the step portion 18-2 of the notch 14 moves toward a side of the stretched portion 12. A portion of the stretched portion 12 enters the inside of the notch 14 and the notch 14 is thereby disposed to surround the stretched portion 12. In this embodiment, the side face of the stretched portion 12 becomes in parallel to the step portion 18-2.

<Effects of First Embodiment>

(1) The bending position of the lead terminal 8 is determined to be the bent portion 20 having the V-shape at which the step portion 18-1 and the notch 14 intersect with each other, and the bending precision of the lead terminal 8 can thereby be improved.

(2) The lead terminal 8 can be bent up to the position at which the lead terminal 8 is in parallel to the lead terminal drawing face 22 of the resin layer 10 without generating any springing back. According to the capacitor 2 including this lead terminal 8, stabilization of the disposition precision can be facilitated for a mounting substrate.

(3) The height of the capacitor 2 can be set to be constant and the first embodiment contributes to height reduction.

### Second Embodiment

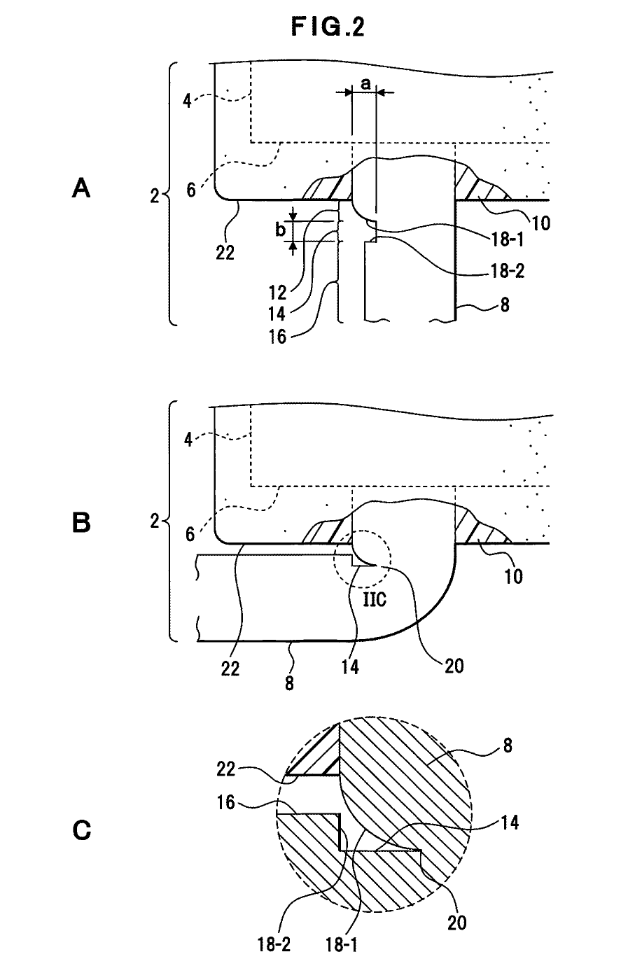

“A” of FIG. 2 depicts a capacitor 2 according to a second embodiment. In “A” of FIG. 2, the same portions as those in “A” of FIG. 1 are given the same reference numerals.

The stretched portion 12 has the bar-like shape having the same diameter in the first embodiment but includes a semispherical curved portion in the second embodiment. The step portion 18-1 is therefore formed by a curved face portion.

Configuring as above, the lead terminal 8 has no corner portion in the step portion 18-1 and has the curved face portion therein. As depicted in B of FIG. 2, the bent portion 20 is therefore formed by bending the lead terminal 8 in the corner portion, which is the border portion between the step portion 18-1 and the notch 14, as the bending starting point. In this bending, the step portion 18-1 is deformed associated with the formation of the bent portion 20 and, thereby, gets away from the step portion 18-2. Any interference between the step portions 18-1 and 18-2 can therefore be avoided.

According to this configuration, the height “a” of the step portion 18-1 and the width b of the notch 14 can be set to have a relation a≧b, and the width b of the notch 14 can be reduced.

Configuring as above, even when the width b of the notch 14 is reduced, the lead terminal 8 can be bent in the corner portion formed by the notch 14 and the step portion 18-1 and any springing back of the lead terminal 8 can be avoided.

The other configurations are same as those in the first embodiment, are therefore given the same reference numerals, and will not again be described.

<Effects of Second Embodiment>

(1) The lead terminal 8 can be bent in the corner portion formed by the notch 14 that is a small-thickness portion having a small width and the step portion 18-1 including the curved face portion, as the bending starting point, and the lead terminal 8 can be bent to be in parallel to the lead terminal drawing face 22 of the resin layer 10, avoiding any springing back of the lead terminal 8. Similarly to the first embodiment, the bending precision of the lead terminal 8 can thereby be improved.

(2) Similarly to the first embodiment, the height of the capacitor 2 is equalized and the precision of the fixation position of the capacitor 2 is therefore improved for the mounting face of a mounting substrate.

### Third Embodiment

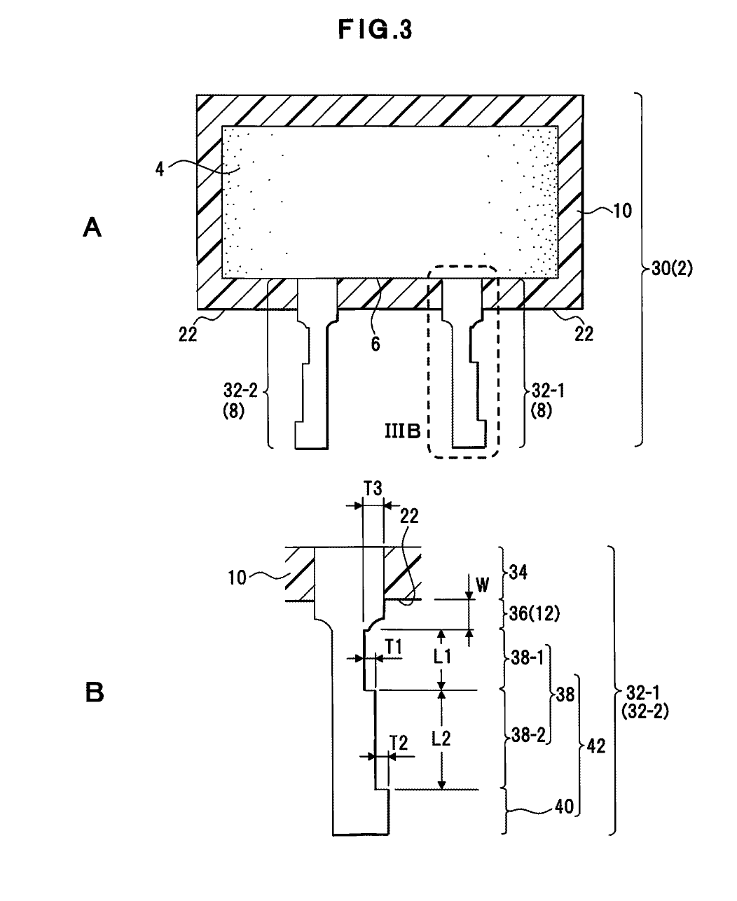

“A” of FIG. 3 depicts a cross section of a solid electrolytic capacitor. The configuration depicted in “A” of FIG. 3 is an example and the present invention is not limited to this configuration.

The lead terminal is traditionally not in parallel to the outer face of the resin layer due to the length of the stretched portion when the lead terminal is bent along the outer face of the resin layer, because the length of the stretched portion generated in the flattening process is not even, and the height of the capacitor may be uneven.

When the flattening process is applied to the lead terminal to provide stability of disposition on the substrate, the flattening can be executed for any desired point while the stretched portion is generated between the flat face and a deriving portion from the resin face in the lead terminal. The border between the stretched portion and the flat face is the bending position. The length of the stretched portion is not even and the bending position is also uneven. When the stretched portion is longer and a position more distant from the resin face acts as the bending position, the bending angle of the lead terminal tends to be an acuter angle, and the stability of the disposition of the lead terminal on the substrate may be degraded.

The capacitor of this embodiment includes a means that limits the bending angle of the lead terminal regardless of the length of the stretched portion generated by the bending of the lead terminal A solid electrolytic capacitor 30 depicted in “A” of FIG. 3 (hereinafter, simply referred to as “capacitor 30”) is an example of the capacitor of the present invention. The capacitor element 4 wound in a cylinder-like shape is used in the capacitor 30. An anode lead terminal 32-1 is connected to an anode electrode foil of the capacitor element 4, and a cathode lead terminal 32-2 is connected to a cathode electrode foil thereof. These lead terminals 32-1 and 32-2 are drawn from the element end face 6 of the capacitor element 4.

A resin mold is applied to the capacitor element 4 using the resin layer 10 as the outer packaging resin made in an insulating resin. The outer face of the capacitor element 4 is covered with the resin layer 10 and is sealed up in the layer of the resin layer 10. The lead terminals 32-1 and 32-2 of the element end face 6 of the capacitor element 4 therefore penetrate the resin layer 10 and are drawn. The resin layer 10 adheres to the wall faces of the lead terminals 32-1 and 32-2. The state depicted in “A” of FIG. 3 is the state before the bending process executed for the lead terminals 32-1 and 32-2 and is the state where the lead terminals 32-1 and 32-2 are perpendicular to the lead terminal drawing face 22 of the resin layer 10.

B of FIG. 3 depicts a IIIB portion in “A” of FIG. 3 in an enlarged manner. The lead terminal 32-1 is formed by, for example, a column-like wire. A lead terminal main body 34, a stretched portion 36, a notch portion 38, and a protrusion 40 are formed in the lead terminal 32-1. The lead terminal 32-1 includes the stretched portion 36, the notch portion 38, and the protrusion 40 between the root side thereof on which the lead terminal main body 34 penetrates the inside of the layer of the resin layer 10 and is exposed from the resin layer 10, and the tip thereof. The notch portion 38 and the protrusion 40 are formed on a flat face portion 42 of each of the lead terminals 32-1 and 32-2. The flat face portion 42 is an example of, for example, the flat portion and is a portion formed by pressuring a round bar-like lead terminal material to have thereon a flat face.

The lead terminal main body 34 is held by the resin layer 10. The stretched portion 36 is an example of the interval portion of the present invention, and extends from the root side of the lead terminal 32-1 toward the tip thereof, becoming oblate in a parabola. The stretched portion 36 is formed, for example, when the notch portion 38 is formed by executing the pressure forming for the lead terminal 32-1.

The notch portion 38 is an oblate portion formed by the pressure forming for the lead terminal 32-1 and is an example of the small-thickness portion of the present invention. In this embodiment, the notch portion 38 has a first and a second notch portions 38-1 and 38-2 formed therein. The notch portions 38-1 and 38-2 each have a step disposed thereon, have different thicknesses, and are formed for the notch portion 38-2 on the side of the tip to be thicker than the notch portion 38-1. The notch portion 38-2 and the protrusion 40 are an example of plural protrusions. The protrusion 40 present at the end of the lead terminal 32-1 is a protrusion whose height is different from that of the notch portion 38-2 that is another protrusion, and constitutes a protrusion that is higher than the other protrusions.

The protrusion 40 is formed on the side of the end of the notch portion 38-2, and forms the end of the lead terminal 32-1. This protrusion 40 is formed to be thicker than the notch portion 38-2.

The width of the stretched portion 36 (a stretched portion width) will be denoted by “W”. The length of the notch portion 38-1 (a notch portion length) will be denoted by “L1”. The length of the notch portion 38-2 (another notch portion length) will be denoted by “L2”. The depth of the notch portion 38-1 (a notch portion depth) will be denoted by “T1”. The depth of the notch portion 38-2 (another notch portion depth) will be denoted by “T2”. The difference between the side face of the lead terminal and the bottom face of the notch portion 38-1 of the anode lead terminal 32-1 will be denoted by “T3”. The relations of the magnitude among these are, for example, as follows.

W<L1

W≦T1+T2

T1=T2 or T1≠T2

T3≦L1

In this case, the height of the protrusion 40 relative to the notch portion 38-2 is T2, and the height of the protrusion 40 relative to the notch portion 38-1 is T1+T2. The stretched portion 36 is accommodated in the notch portion 38-1 that is the small-thickness portion.

The lead terminal 32-1 has been described while the lead terminal 32-2 is same as the lead terminal 32-1 and will not be described. This bending causes the protrusion 40 to be disposed in the vicinity of the lead terminal drawing face 22 for each of the lead terminals 32-1 and 32-2.

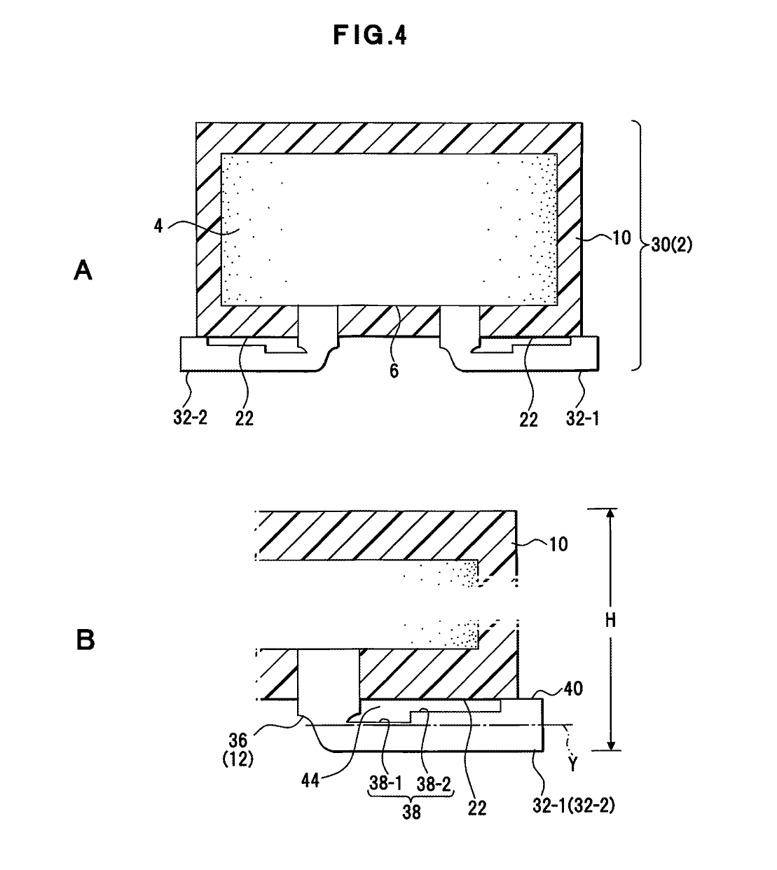

“A” of FIG. 4 depicts the capacitor 30 that includes the lead terminals 32-1 and 32-2 applied with the bending process. The lead terminals 32-1 and 32-2 are each bend in a direction opposite to that of each other, and are disposed in the vicinity of the lead terminal drawing face 22 of the resin layer 10 of the capacitor 30.

B of FIG. 4 depicts in an enlarged manner the side of the lead terminal 32-1 depicted in “A” of FIG. 4. The lead terminal 32-1 is bent in the direction opposite to that of the lead terminal 32-2. The bending process is executed on the inner side of the notch portion 38-1. The stretched portion 36 is therefore deformed and is caused to enter toward the notch portion 38-1, and a space 44 is formed between the notch portion 38-1 and the lead terminal drawing face 22 and between the notch portion 38-2 and the lead terminal drawing face 22. In this case, the protrusion 40 adheres to the lead terminal drawing face 22 and a central line Y of the lead terminal 32-1 in the longitudinal direction thereof is maintained to be in parallel to the lead terminal drawing face 22. A height H of the capacitor 30 is thereby made even.

<Effects of Third Embodiment>

(1) The protrusion 40 is formed on the side of the tip of each of the lead terminals 32-1 and 32-2, and is disposed on the lead terminal drawing face 22 of the resin layer 10. Any jump-up due to the bending of the lead terminals 32-1 and 32-2 can thereby be prevented regardless of the length of the width W of the stretched portion 36. The bending angle of each of the lead terminals 32-1 and 32-2 can be maintained to be constant and any dispersion of the height of the capacitor 30 can be reduced. When the width W is large, for example, the protrusion 40 abuts on the lead terminal drawing face 22 of the resin layer 10 and the angle of the bending is thereby limited. Any increase of the bending angle of each of the lead terminals 32-1 and 32-2 can therefore be prevented even when the width W of the stretched portion 36 is increased and the bending starting point becomes distant from the lead terminal drawing face 22. The disposition precision is stabilized for the circuit substrate.

(2) The height of the capacitor 30 becomes constant and the disposition precision is therefore improved for the circuit substrate to which the capacitor 2 is fixed.

(3) When the notch portion 38 having the different heights and the protrusion 40 are disposed from the stretched portion 36 toward the end of each of the lead terminals 32-1 and 32-2, and the notch portion 38 and the protrusion 40 form, for example, a two-level step, any contact of each of the lead terminals 32-1 and 32-2 can therefore be prevented with the lead terminal drawing face 22 of the resin layer 10 on the side of the notch portion 38. As a result, the bending angles of the bent lead terminals 32-1 and 32-2 can be made even and the dispersion of the height of the capacitor 30 can be reduced. With the two-level step, a portion having a large thickness is disposed in the notch portion 38 between the stretched portion 36 and the protrusion 40, and the strength of the lead terminals can thereby be maintained. The structure having the step with the different levels disposed therein is a structure that prevents any contact of each of the lead terminals 32-1 and 32-2 with the lead terminal drawing face 22 on the side of the notch portion 38 during the execution of the bending process for the lead terminals, and is also a structure that can secure the thickness necessary for maintaining the strength of the lead terminals 32-1 and 32-2.

(4) The notch portions 38-1 and 38-2 are formed, deepening in incremental steps and the processing stress is thereby reduced when the lead terminals 32-1 and 32-2 are processed. The notch portion 38-1 to be the small-thickness portion is formed to be deep to constitute plural levels, and generation of any bending strain can thereby be prevented and the strength of the lead terminals 32-1 and 32-2 can be maintained.

(5) The small-thickness portion formed as the notch portion 38-1 is the portion having the smallest thickness of each of the lead terminals 32-1 and 32-2, and is the starting point for the bending process. The bending position can thereby be set to be the small-thickness portion. By configuring as above, the dispersion of the height of the capacitor 30 can be reduced.

(6) Preferably, the width W of the stretched portion 36 in this embodiment is set to be, for example, W=0.02 to 0.1 [mm] by taking into consideration the strength of the lead terminals 32-1 and 32-2 and the number of process steps for the lead terminals 32-1 and 32-2.

### Fourth Embodiment

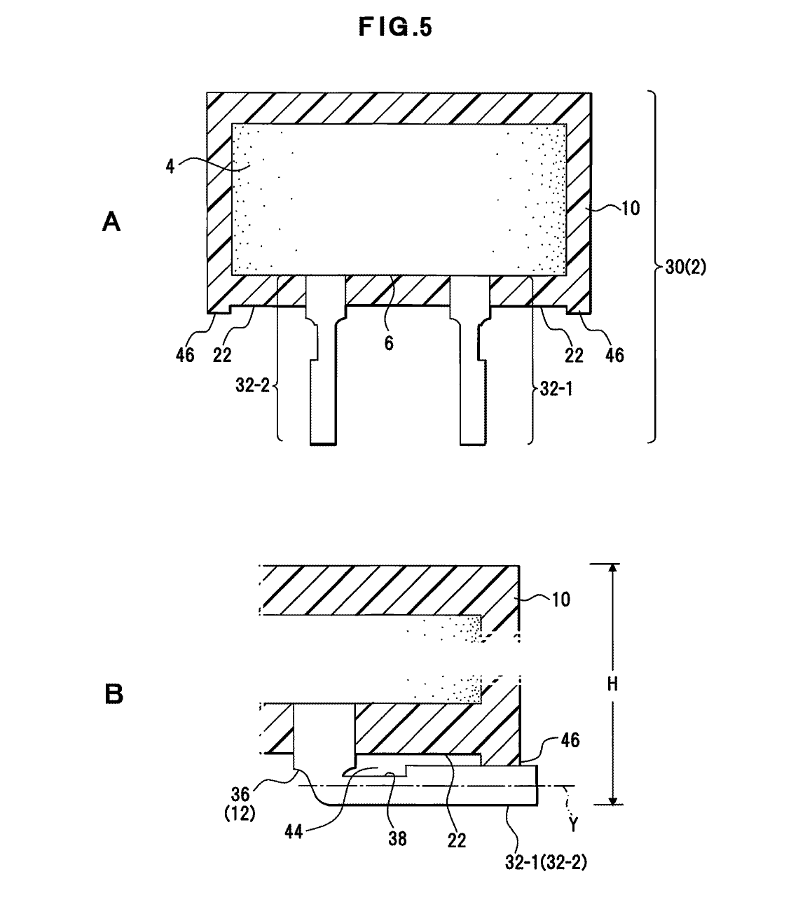

“A” of FIG. 5 depicts a solid electrolytic capacitor according to a fourth embodiment. In “A” of FIG. 5, the same portions as those in FIG. 4 are given the same reference numerals.

In the capacitor 30 of this embodiment, a protrusion 46 is formed, for example, on an edge side of the lead terminal drawing face 22 of the resin layer 10. The height of the protrusion 46 may be set to be equal to the depth of the notch portion 38-2 described above that is an example of the small-thickness portion, that is, the height T2 of the protrusion 40 from the bottom face of the notch portion 38-2.

Configuring as above, as depicted in B of FIG. 5, when the lead terminals 32-1 and 32-2 are bent each in the notch portion 38 in the direction opposite to that of each other to be applied with the bending process, the side walls of the lead terminals 32-1 and 32-2 are each disposed in the vicinity of the protrusion 46 formed on the lead terminal drawing face 22. In this case, a portion of each of the lead terminals 32-1 and 32-2 abuts on the protrusion 46 and the bending angles of the lead terminals 32-1 and 32-2 can thereby be limited. The lead terminals 32-1 and 32-2 are therefore horizontally maintained. Any jump-up of the lead terminals 32-1 and 32-2 can be prevented and, for the lead terminals 32-1 and 32-2, for example, the central line Y indicating the center in the longitudinal direction is maintained in parallel to the lead terminal drawing face 22 on the flat face side. Thereby, the height H of the capacitor 30 can be maintained to be even.

<Effects of Fourth Embodiment>

(1) The capacitor 30 has the lead terminals 32-1 and 32-2 each disposed against the protrusion 46 disposed on the side of the lead terminal drawing face 22 present on a deriving face of the lead terminals 32-1 and 32-2. The angle at which each of the lead terminals 32-1 and 32-2 is bent is limited by, for example, the contact of the flat portion with the protrusion 46. The bending positions of the lead terminals 32-1 and 32-2 can thereby be maintained to be constant regardless of the length of the width W of the stretched portion 36. The dispersion of the bending height can therefore be reduced.

(2) The bending state of each of the lead terminals 32-1 and 32-2 is stabilized and the height of the capacitor 30 is thereby made even. The fixation position precision of the capacitor 30 mounted on the substrate is therefore improved.

### OTHER EMBODIMENTS

The solid electrolytic capacitor is exemplified as an example in the above embodiments while the capacitor of the present invention may be another capacitor such as an electrolytic capacitor.

Aspects of the capacitor and the manufacturing method therefor extracted from the above embodiments are as follows.

The capacitor is the capacitor including the capacitor element to which a lead terminal is connected and that is covered with a resin. The lead terminal is derived from the resin layer covering the capacitor element, and includes the interval portion exposed from the outer surface of the resin layer, the small-thickness portion, and the step portion that is the border portion between the interval portion and the small-thickness portion, and the small-thickness portion is bent toward the step portion, is disposed on the side of the resin layer and is disposed to superpose the small-thickness portion on the step portion and to surround the interval portion.

Preferably, in the capacitor, the height of the step portion may be set to be smaller than the width of the small-thickness portion.

Preferably, in the capacitor, the protrusion may be formed on the side face portion of the lead terminal or the protrusion may be formed on the outer face side of the resin layer from which the lead terminal is derived and, due to the bending of the lead terminal, the protrusion of the lead terminal may be disposed in the vicinity of the outer face portion of the resin layer, or the lead terminal may be disposed in the vicinity of the protrusion formed on the resin layer facing the lead terminal.

Preferably, in the capacitor, due to the bending of the lead terminal, the protrusion of the lead terminal may abut on the resin face of the outer face side of the resin layer or the lead terminal may abut on the protrusion of the resin layer to limit the bending angle of the lead terminal by the protrusion of the lead terminal or the protrusion of the resin layer

Preferably, in the capacitor, the plurality of protrusions having different heights may be disposed between the end of the lead terminal and the small-thickness portion, and the height of the protrusion on the side of the end of the protrusions may be set to be higher than those of other protrusions.

The manufacturing method for a capacitor is the manufacturing method for the capacitor including the capacitor element to which a lead terminal is connected and that is covered with a resin. The manufacturing method includes the processes of deriving the lead terminal from the resin layer covering the capacitor element, exposing the interval portion from the outer face of the resin layer, forming the small-thickness portion in the lead terminal to dispose the step portion between the interval portion and the small-thickness portion, bending the lead terminal in the small-thickness portion toward the step portion and disposing the small-thickness portion to superpose the small-thickness portion on the step portion and to surround the interval portion.

Preferably, the manufacturing method for a capacitor may include the process of forming the height of the step portion to be smaller than the width of the small-thickness portion.

Preferably, the manufacturing method for a capacitor may further include the processes of forming the protrusion on the side face portion of the lead terminal or forming the protrusion on the outer face side of the resin layer from which the lead terminals is derived; and due to the bending of the lead terminal, causing the protrusion of the lead terminal to be disposed in the vicinity of the outer face portion of the resin layer or causing the lead terminal to be disposed in the vicinity of the protrusion formed on the resin layer facing the lead terminal.

Preferably, the manufacturing method for a capacitor may include the processes of, due to the bending of the lead terminal, causing the protrusion of the lead terminal to abut on the resin face of the outer face side of the resin layer or causing the lead terminal to abut on the protrusion of the resin layer to limit the bending angle of the lead terminal by the protrusion of the lead terminal or the protrusion of the resin layer.

The functions and effects of the capacitor and the manufacturing method therefor described above will be listed as follows.

(1) The bending position of the lead terminal can be maintained to be constant, any recovery from the bent figure can be prevented, and the bending precision of the lead terminal can be improved.

(2) The height of the capacitor becomes constant, and the disposition precision can therefore be improved on the circuit board to fix the capacitor to.

As above, the preferred embodiments, etc., of the present invention have been described. The present invention is not limited by the above description. Those skilled in the art can make various modifications and changes thereto based on the gist of the present invention described in the claims or disclosed in the modes for carrying out the invention. Needless to say, such modifications and changes are included in the scope of the present invention.

The present invention provides a capacitor such as a solid electrolytic capacitor covered with a resin layer using a resin mold. The shaping precision of the lead terminals thereof can be improved. Improvement of the position precision for the mounting substrate and stabilization of the height of the capacitor can be facilitated.

What is claimed is:

1. A capacitor comprising a capacitor element to which a lead terminal is connected and that is covered with a resin, wherein
the lead terminal is derived from a resin layer covering the capacitor element, and comprises:
an interval portion exposed from an outer face of the resin layer;
a small-thickness portion; and
a step portion that is a border portion between the interval portion and the small-thickness portion, and wherein
the small-thickness portion is bent toward the step portion, is disposed on a side of the resin layer and is disposed to superpose the small-thickness portion on the step portion and to surround the interval portion.

2. The capacitor of claim 1, wherein
a height of the step portion is set to be smaller than a width of the small-thickness portion.

3. The capacitor of claim 1, wherein
a protrusion is formed on a side face portion of the lead terminal or a protrusion is formed on an outer face side of the resin layer from which the lead terminal is derived, and wherein
due to bending of the lead terminal, the protrusion of the lead terminal is disposed in a vicinity of an outer face portion of the resin layer, or the lead terminal is disposed in a vicinity of the protrusion formed on the resin layer facing the lead terminal.

4. The capacitor of claim 2, wherein
a protrusion is formed on a side face portion of the lead terminal or a protrusion is formed on an outer face side of the resin layer from which the lead terminal is derived, and wherein
due to bending of the lead terminal, the protrusion of the lead terminal is disposed in a vicinity of an outer face portion of the resin layer, or the lead terminal is disposed in a vicinity of the protrusion formed on the resin layer facing the lead terminal.

5. The capacitor of claim 3, wherein
due to the bending of the lead terminal, the protrusion of the lead terminal abuts on a resin face of the outer face side of the resin layer or the lead terminal abuts on the protrusion of the resin layer to limit a bending angle of the lead terminal by the protrusion of the lead terminal or the protrusion of the resin layer.

6. The capacitor of claim 4, wherein
due to the bending of the lead terminal, the protrusion of the lead terminal abuts on a resin face of the outer face side of the resin layer or the lead terminal abuts on the protrusion of the resin layer to limit a bending angle of the lead terminal by the protrusion of the lead terminal or the protrusion of the resin layer.

7. The capacitor of claim 1, wherein
the lead terminal further comprises a plurality of protrusions having different heights between an end of the lead terminal and the small-thickness portion, and wherein
a height of the protrusion on the side of the end of the protrusions is set to be higher than those of the other protrusions.

8. A manufacturing method for a capacitor comprising a capacitor element to which a lead terminal is connected and that is covered with a resin, the manufacturing method comprising the steps of:
deriving the lead terminal from a resin layer covering the capacitor element, and exposing an interval portion from an outer face of the resin layer;
forming a small-thickness portion in the lead terminal to dispose a step portion between the interval portion and the small-thickness portion; and
bending the lead terminal in the small-thickness portion toward the step portion and disposing the small-thickness portion to superpose the small-thickness portion on the step portion and to surround the interval portion.

9. The manufacturing method for a capacitor of claim 8, further comprising the step of
forming a height of the step portion to be smaller than a width of the small-thickness portion.

10. The manufacturing method for a capacitor of claim 8, further comprising the steps of:
forming a protrusion on a side face portion of the lead terminal or forming a protrusion on an outer face side of the resin layer from which the lead terminal is derived; and
due to the bending of the lead terminal, causing the protrusion of the lead terminal to be disposed in a vicinity of the outer face portion of the resin layer or causing the lead terminal to be disposed in a vicinity of the protrusion formed on the resin layer facing the lead terminal.

11. The manufacturing method for a capacitor of claim 10, further comprising the step of:
due to the bending of the lead terminal, causing the protrusion of the lead terminal to abut on a resin face of the outer face side of the resin layer or causing the lead terminal to abut on the protrusion of the resin layer to limit a bending angle of the lead terminal by the protrusion of the lead terminal or the protrusion of the resin layer.
